(19) United States
(12) Patent Application Publication
(10) Pub. No.: US 2014/0344171 A1
(43) Pub. Date: Nov. 20, 2014

(54) METHODS AND SYSTEMS FOR ESTIMATING OFFICE ACTIONS

(71) Applicant: CPA GLOBAL SUPPORT SERVICES PVT LTD, Noida (IN)

(72) Inventors: Ashish Porwal, Udaipur (IN); Ashish Heda, Udaipur (IN)

(73) Assignee: CPA GLOBAL SUPPORT SERVICES PVT LTD, Noida (IN)

(21) Appl. No.: 14/354,269

(22) PCT Filed: Nov. 8, 2012
(86) PCT No.: PCT/IB2012/002268

§ 371 Date: Apr. 25, 2014

(30) Foreign Application Priority Data
Oct. 27, 2011 (IN) 3058/DEL/2011

(51) Int. Cl. G06Q 10/10; G06Q 50/18

(52) U.S. Cl. CPC G06Q 10/10; G06Q 50/184
USPC 705/310

(57) ABSTRACT

A method and computer readable medium for a method for forecasting Office Actions for a patent portfolio The method includes performing predefined statistical analysis on a set of patents, wherein the set of patents and the patent portfolio have similar patent distribution; identifying one or more Office Action parameters associated with the set of patents and the patent portfolio based on the predefined statistical analysis performed on the set of patents; and estimating the number of Office Actions issued for the patent portfolio based on the predefined statistical analysis performed on the set of patents and the identified Office Action parameters identified.

### CROSS REFERENCE TO RELATED APPLICATIONS

This application claims the benefit of Indian Provisional Application No. 3058/DEL/2011, entitled, “A Method for Forecasting Number and Timing of Office Actions on A Portfolio of Patent Applications”, filed on Oct. 27, 2011, which is incorporated herein in its entirety by reference.

### BACKGROUND

The invention relates generally to intellectual property and more particularly to estimating Office Actions for a patent portfolio.

Intangible assets, such as patents and trademarks are vital to society and the economy. They provide incentives for individual inventors and corporations to engage in research and development (R&D). Without patents, third parties will be free to exploit any new inventions, with the result that fewer inventors and corporations will be willing to invest in R&D and technological advances will be stifled.

A patent portfolio may help a business to protect its investments, revenues and assets. For example, a strong patent portfolio may create barriers to entry for competitors and preserve an exclusive market space for products and services offered by a business. A patent portfolio may be valuable to a business because it generates revenue through patent licensing or assignments. It may be a powerful bargaining tool for obtaining access to other patented technologies, e.g., by cross-licensing. A patent portfolio may also serve as a defensive tool when facing a patent infringement suit. For example, a company with a broad and strong patent portfolio may counter-sue for infringement of its own patents and force the suing party into settlement quickly.

Therefore, importance of patents as assets is ever increasing. As a result the expenditures on developing, maintaining, and protecting these assets have also increased considerably. Like all other large expenditures, expenditures on drafting, filing, prosecuting, and maintaining patents too need to be budgeted. Patent prosecution expenditure forms a substantial portion of the intellectual property budgets of companies thriving on innovation and is hence attracting the attention of patent offices (PTOs) such as the USPTO.

In the process of assessing a patent application for grant, a PTO usually raises objections or rejections over the claims and other elements of a patent application. PTOs present these issues in the form of an Office Action (OA) which needs to be replied by the applicant before the PTO can proceed further with its assessment. More is the number of OAs, more is the prosecution cost. However, as both the number and timing of OAs for patent applications are uncertain, it is difficult to create a budget for prosecution of patent applications that is very accurate.

Some conventional methods provide estimates of OA timings but that too is probabilistic. Due to the uncertainty involved, it is difficult to accurately estimate the OA timing for a specific application.

There is therefore a need to provide a method that can efficiently and accurately estimate the number of office actions for a given patent portfolio.

### BRIEF DESCRIPTION OF THE FIGURES

The present application can be best understood by reference to the following description taken in conjunction with the accompanying drawing figures, in which like parts may be referred to by like numerals:

FIG. 1 is a flowchart of a method for forecasting Office Actions for a patent portfolio, in accordance with an embodiment.

FIG. 2 is a flowchart of a method for forecasting Office Actions for a patent portfolio by creating multiple categories, in accordance with an embodiment.

FIG. 3 illustrates an exemplary computing system that may be employed to implement processing functionality for various embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

Various embodiments provide methods, systems, and computer readable medium for forecasting Office Actions for a patent portfolio. The method includes performing predefined statistical analysis on a set of patents, wherein the set of patents and the patent portfolio have similar patent distribution; identifying one or more Office Action parameters associated with the set of patents and the patent portfolio based on the predefined statistical analysis performed on the set of patents; and estimating the number of Office Actions issued for the patent portfolio based on the predefined statistical analysis performed on the set of patents and the identified Office Action parameters identified.

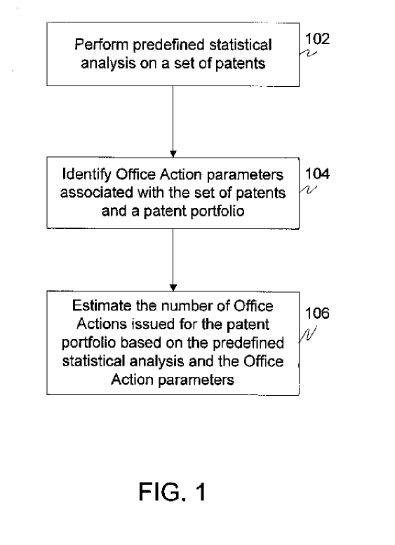

FIG. 1 is a flowchart of a method for forecasting Office Actions for a patent portfolio, in accordance with an embodiment. The patent portfolio may include patent applications. The patent portfolio may be created for a particular Assignee, inventor, or a technology field. To forecast Office Actions for the patent portfolio, a set of patents is selected that includes patent applications and granted patents. The patent distribution within the set of patents is similar to the patent distribution in the patent portfolio. The patent distribution may be based on, but is not limited to technology, companies, organizations, inventors, attorneys, and examiners. For example, if the patent portfolio is that of a company ABC, it is desirable that the set of patents also belong to the same company. In this case, the filing/priority date for the patents in the set of patents should predate the patents in the patent portfolio. Thus, the set of patents may be historical dataset for the patent portfolio. By way of another example, if the patent portfolio is for a telecommunication field, the set of patents may also be selected such that each patent in the set of patents is from the telecommunication field.

After selecting the set of patents, for each patent in the set of patents, the time period between the filing date of a patent and the date of receiving the first Office Action is computed, in an embodiment. In other words, time to first Office Action (TTOA1) is computed. In an alternate embodiment, the time period between the filing date of a patent and the date of receiving the second Office Action is computed. In other words, time to second Office Action (TTOA2) is computed. Thereafter, a predefined statistical analysis is performed on the set of patents at 102. The predefined statistical analysis may include, but is not limited to standard deviation, mean, geometric mean, harmonic mean, weighted mean, median, Regression Analysis, multi variate statistical analysis, Analysis Of Variance (ANOVA), or mode. Based on the result of predefined statistical analysis, Office Action parameters associated with the set of patents and the patent portfolio are identified at 104. The Office Action Parameters facilitate forecasting of Office Actions for the patent portfolio as the number of Office Actions that may be received for a given set of patent is a function of Office Action parameters for that set of patents. The Office Action parameters may include, but are not limited to filing date of a patent document, priority date of a patent document, Attorney, law-firm, Examiner, Assignee, Inventors, filing date of response to Office Action, filing date of a Notice of Appeal, filing date of an Appeal Brief, filing date of a pre-Appeal Brief, mailing date of an Advisory Action, filing date of a Request for Continued Examination (RCE). Nominal data such as Attorney, law-firm, Examiner, Assignee, Inventors may be converted to ordinal or ratio forms.

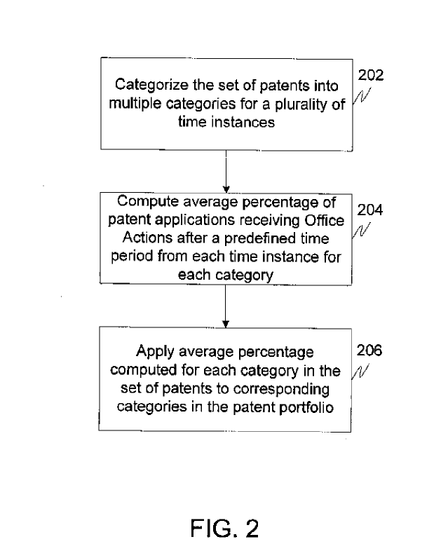

In an embodiment, average and standard deviation of TTOA1 for the set of patents is calculated. Based on this, it is determined that priority date of the patents in the set of patents influence TTOA1 and thus priority date is identified as an Office Action parameter. Additionally, it is determined that the priority dates may also influence TTOA1 for the patent applications in the patent portfolio. In this case, as priority date is identified as an Office Action Parameter, the set of patents is further categorized into multiple categories to reflect differences due to priority dates. This is further explained in conjunction with FIG. 2.

After performing the predefined statistical analysis and identifying the Office Action parameters, at 106 the number of Office Actions that may be issued for the patent portfolio within a given time period is estimated using the predefined statistical analysis and the Office Action parameters. In an embodiment, when the patent portfolio is divided into multiple categories, the number of Office Actions for each category are estimated and are then combined to determine the total number of Office Actions that are expected for the patent portfolio. This is further explained in conjunction with FIG. 2. An Office Action may be a first Office-Action, a second Office Action, a non-final Office Action, a Final Office Action, an Office Action received after RCE, an Office Action received after filing Appeal Brief, a notice of allowance, and an issue notification. It will be apparent to a person skilled in the art that a non-final Office Action may be a first, second, or third Office Action and a final Office Action may be second or third Office Action.

FIG. 2 is a flowchart of a method for forecasting Office Actions for a patent portfolio by creating multiple categories, in accordance with an embodiment. To estimate the number of Office Actions for the patent portfolio, at 202 the set of patents is categorized into multiple categories based on one or more Office Action Parameters and the predefined statistical analysis performed on the set of patents. In addition to the set of patents, the patent portfolio is also categorized into similar multiple categories.

In an embodiment, as explained in the description of FIG. 1, it is determined that priority date of the patents in the set of patents influence TTOA1 and thus priority date is identified as an Office Action parameter. Thus, the set of patents are categorized into multiple categories so as to reflect the differences due to priority dates of patents in the set of patents. Similarly, the patent portfolio is also categorized so as to reflect the differences due to priority dates of patent applications in the patent portfolio.

To categorize the set of patents, the average and standard deviation of TTOA1 computed for the set of patents is used. In an exemplary embodiment, the set of patents may be divided into three categories: Recent Patents, Average Patents, and Old Patents. To this end, time since filing (TSF) to the time of analyzing the set of patents for each patent in the set of patents is determined. Based on this, the patents are categorized as described in 1, 2, and 3:

Recent Patents: TSF<‘Average-1standard deviation’ (1)

Average Patents:

‘Average-1standard deviation’<TSF<‘Average+1standard deviation’ (2)

Old Patents: TSF>‘Average+1standard deviation’ (3)

In other words, each patent which has TSF that is less than ‘Average-1standard deviation’ is categorized as Recent Patent. Each patent which has TSF that falls between ‘Average-1 standard deviation’ and ‘Average+1standard deviation’ is categorized as Average Patent. Finally, each patent which has TSF that is greater than ‘Average+1standard deviation’ is categorized as Old Patent.

A patent may be Recent, Average, or Old based on the time when it is analyzed. Therefore, in an embodiment, the multiple categories for the set of patents may be created for a plurality of time instances in order to capture this variation. The plurality of time instances may be at fixed time intervals. In an embodiment, each time instance is separated from adjacent time instance by one month. For example, if the filling dates in the set of patents span over a period of 5 years, then 30 time instances may be selected such that each time instance is a month apart from an adjacent time instance.

Thereafter, at each time instance for each of the multiple categories, average percentage of patent applications that will receive Office Action after a predefined time period from each time instance is computed at 204. In other words, for a particular time instance, average percentage of patent applications that will receive Office Action within the predefined time period from that particular time instance is computed for all the categories. In an embodiment, for a time instance three categories are created: Recent Patents, Average Patents, and Old patents. For each of these categories the number of patents that have a first Office Action pending at the time instance are computed. Thereafter, for each of the Recent, Average, and Old patents category, the percentage of application that receive first Office Action within a given time period (T) from the time instance is computed. This computation of percentages is repeated for each time instance in the plurality of time instances.

For each of the three categories, an average of the percentages computed for the plurality of time instance is calculated. The average percentage for the Recent Patents category may be represented as R_{T}, the average percentage for the Average Patents category may be represented is represented as A_{T}, and the average percentage for the Old Patents category is represented as O_{T}. Therefore, at any point of time for the set of patents, R_{T}, A_{T}, and O_{T} may represented as:

$${R}_{T} = \frac{( \begin{matrix}Patents in the Recent Patent category that receive \\ a first Office Action after the time period\end{matrix} )}{( \begin{matrix}Patents in the Recent Patent category \\ that have a first Office Action pending\end{matrix} )}$$

$${A}_{T} = \frac{( \begin{matrix}Patents in the Average Patent category that receive \\ a first Office Action after the time\end{matrix} ) \times 100}{( \begin{matrix}Patents in the Average Patent category \\ that have a first Office Action pending\end{matrix} )}$$

$${O}_{T} = \frac{( \begin{matrix}Patents in the Old Patent category that receive a \\ first Office Action after the time period T\end{matrix} ) \times 100}{( \begin{matrix}Patents in the Recent Patent category \\ that have a first Office Action pending\end{matrix} )}$$

The average percentage of patents receiving Office Action within the predefined time period calculated for the set of patents is used to estimate the number of Office Actions that may be issued for the patent portfolio. As explained above in detail, the patent portfolio is also categorized into multiple categories similar to the categorization of the set of patents. In an embodiment, the patent portfolio may also be categorized into three categories using priority dates of patent applications in the patent portfolio. The three categories in the patent portfolio thus may also be Recent Patents, Average Patents, and Old Patents.

Therefore, to estimate the number of Office Actions that may be issued for the patent portfolio within the predefined time period, at 206 average percentage computed for each category in the set of patents is applied to corresponding categories in the patent portfolio. In an embodiment, R_{T} is applied to Recent Patents category in the patent portfolio to estimate number of patent applications that may receive first Office Action within the time period T. Similarly, A_{T} and O_{T} are applied to Average and Old patents category respectively in the patent portfolio to estimate number of patent applications that may receive first Office Action within the time period T in the Average and Old patents category. Thereafter, the estimated number of first Office Actions for each of the three categories are combined to compute the total number of first Office Actions estimated within the timer period T for the patent portfolio.

In an embodiment, to estimate the number of second Office Actions for the patent portfolio, the predefined statistical analysis is used to determine the impact of variables like TTOA1, priority date, filing date, law-firm name on TTOA2 for the set of patent. Based on the results of the predefined statistical analysis a relationship between TTOA2 and other variables is determined for the set of patents. The relationship so determined is thereafter applied to patent applications that have already received their first Office Action in the patent portfolio. Additionally, for patent applications that have not received their first Office Action, an estimated date for the first Office Action may be used. Similarly, the number of third and fourth Office Actions can be estimated for the patent portfolio. Therefore, the number of first Office Actions, second Office Actions, and third Office Actions that are estimated to be received within the predefined time period for the patent portfolio may be added to estimate the total number of Office Actions that may be received within the predefined time period for the patent portfolio.

The method described in 102 to 106 and 202 to 206 may also be used to estimate the number of patent application in the patent portfolio that will get granted in the predefined time period.

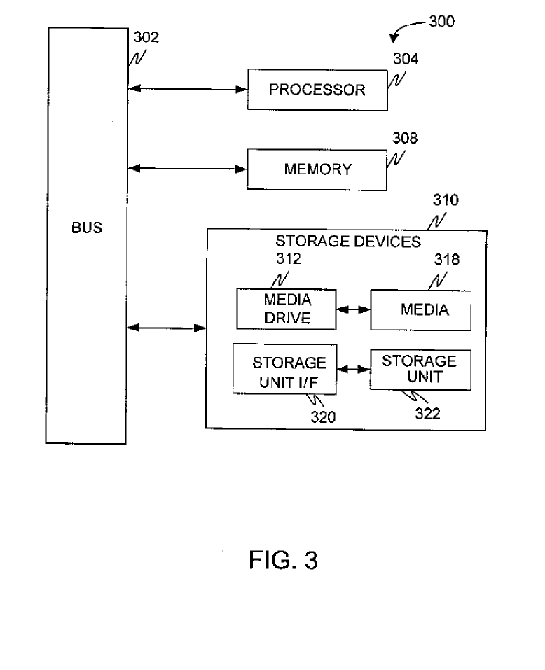

FIG. 3 illustrates an exemplary computing system 300 that may be employed to implement processing functionality for various embodiments of the invention (e.g., as a SIMD device, client device, server device, one or more processors, or the like). Those skilled in the relevant art will also recognize how to implement the invention using other computer systems or architectures. Computing system 300 may represent, for example, a user device such as a desktop, mobile phone, personal entertainment device, DVR, and so on, a mainframe, server, or any other type of special or general purpose computing device as may be desirable or appropriate for a given application or environment. Computing system 300 can include one or more processors, such as a processor 304. Processor 304 can be implemented using a general or special purpose processing engine such as, for example, a microprocessor, microcontroller or other control logic. In this example, processor 304 is connected to a bus 302 or other communication medium.

Computing system 300 can also include a main memory 308, preferably random access memory (RAM) or other dynamic memory, for storing information and instructions to be executed by processor 304. Main memory 308 also may be used for storing temporary variables or other intermediate information during execution of instructions to be executed by processor 304. Computing system 300 may likewise include a read only memory (“ROM”) or other static storage device coupled to bus 302 for storing static information and instructions for processor 304.

Computing system 300 may also include information storage mechanism 310, which may include, for example, a media drive 312 and a removable storage interface 320. The media drive 312 may include a drive or other mechanism to support fixed or removable storage media, such as a hard disk drive, a floppy disk drive, a magnetic tape drive, an optical disk drive, a CD or DVD drive (R or RW), or other removable or fixed media drive. A storage media 318 may include, for example, a hard disk, floppy disk, magnetic tape, optical disk, CD or DVD, or other fixed or removable medium that is read by and written to by media drive 312. As these examples illustrate, storage media 318 may include a computer-readable storage medium having stored therein particular computer software or data.

In alternative embodiments, information storage mechanism 310 may include other similar instrumentalities for allowing computer programs or other instructions or data to be loaded into computing system 300. Such instrumentalities may include, for example, a removable storage unit 322 and an interface 320, such as a program cartridge and cartridge interface, a removable memory (for example, a flash memory or other removable memory module) and memory slot, and other removable storage units 322 and interfaces 320 that allow software and data to be transferred from removable storage unit 322 to computing system 300.

In this document, the terms “computer program product” and “computer-readable medium” may be used generally to refer to media such as, for example, memory 308, storage device 318, storage unit 322. These and other forms of computer-readable media may be involved in providing one or more sequences of one or more instructions to processor 304 for execution. Such instructions, generally referred to as “computer program code” (which may be grouped in the form of computer programs or other groupings), when executed, enable computing system 300 to perform features or functions of embodiments of the present invention.

In an embodiment where the elements are implemented using software, the software may be stored in a computer-readable medium and loaded into computing system 300 using, for example, removable storage drive 314 or drive 312. The control logic (in this example, software instructions or computer program code), when executed by processor 304, causes processor 304 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for forecasting Office Actions for a patent portfolio, the method comprising:
performing predefined statistical analysis on a set of patents, wherein the set of patents and the patent portfolio have similar patent distribution;
identifying one or more Office Action parameters associated with the set of patents and the patent portfolio based on the predefined statistical analysis performed on the set of patents; and
estimating the number of Office Actions issued for the patent portfolio based on the predefined statistical analysis performed on the set of patents and the identified Office Action parameters identified.

2. The method of claim 1, wherein the patent distribution is based on one or more of technology, companies, organizations, inventors, attorneys, law firms, and examiners.

3. The method of claim 1, wherein the predefined statistical analysis comprises standard deviation, mean, geometric mean, harmonic mean, weighted mean, median, Regression Analysis, multi variate statistical analysis, Analysis Of Variance (ANOVA), and mode.

4. The method of claim 1, wherein the one or more Office Action parameters comprise filing date of a patent document, priority date of a patent document, Attorney, law-firm, Examiner, Assignee, Inventors, filing date of response to Office Action, filing date of a Notice of Appeal, filing date of an Appeal Brief, filing date of a pre-Appeal Brief, mailing date of an Advisory Action, filing date of a Request for Continued Examination (ACE).

5. The method of claim 1, wherein the number of Office Actions is a function of the one or more Office Action parameters.

6. The method of claims 1, wherein the Office Actions comprise one of a first Office Action, a second Office Action, a non-final Office Action, a Final Office Action, an Office Action received after RCE, an Office Action received after filing Appeal Brief, a notice of allowance, and an issue notification.

7. The method of claim 1, wherein estimating comprises categorizing the set of patents and the patent portfolio into multiple categories based on one or more Office Action Parameters and the predefined statistical analysis performed on the set of patents.

8. The method of claim 7, wherein the multiple categories are created for a plurality of time instances.

9. The method of claim 8, wherein estimating further comprises for the set of patents, computing at each time instance for each of the multiple categories, average percentage of patent applications receiving Office Action after a predefined time period from each time instance.

10. The method of claim 9 further comprising applying average percentage computed for each category to corresponding categories in the patent portfolio to estimate the number of Office Actions within the predefined time period for the patent portfolio.

11. A tangible computer readable medium having encoded thereon computer-executable instructions which, when executed by a computer, cause the computer to perform a method for forecasting Office Actions for a patent portfolio, the method comprising:
performing predefined statistical analysis on a set of patents, wherein the set of patents and the patent portfolio have similar patent distribution;
identifying one or more Office Action parameters associated with the set of patents and the patent portfolio based on the predefined statistical analysis performed on the set of patents; and
estimating the number of Office Actions issued for the patent portfolio based on the predefined statistical analysis performed on the set of patents and the identified Office Action parameters identified.

12. The tangible computer readable medium of claim 11, wherein the patent distribution is based on one or more of technology, companies, organizations, inventors, attorneys, law firms, and examiners.

13. The tangible computer readable medium of claim 11, wherein the predefined statistical analysis comprises standard deviation, mean, geometric mean, harmonic mean, weighted mean, median, Regression Analysis, multi variate statistical analysis, Analysis Of Variance (ANOVA), and mode.

14. The tangible computer readable medium of claim 11, wherein the one or more Office Action parameters comprise filing date of a patent document, priority date of a patent document, Attorney, law-firm, Examiner, Assignee, Inventors, filing date of response to Office Action, filing date of a Notice of Appeal, filing date of an Appeal Brief, filing date of a pre-Appeal Brief, mailing date of an Advisory Action, filing date of a Request for Continued Examination (RCE).

15. The tangible computer readable medium of claim 11, wherein the number of Office Actions is a function of the one or more Office Action parameters.

16. The tangible computer readable medium of claims 11, wherein the Office Actions comprise one of a first Office Action, a second Office Action, a non-final Office Action, a Final Office Action, an Office Action received after RCE, an Office Action received after filing Appeal Brief, a notice of allowance, and an issue notification.

17. The tangible computer readable medium of claim 11, wherein estimating comprises categorizing the set of patents and the patent portfolio into multiple categories based on one or more Office Action Parameters and the predefined statistical analysis performed on the set of patents.

18. The tangible computer readable medium of claim 17, wherein the multiple categories are created for a plurality of time instances.

19. The tangible computer readable medium of claim 18, wherein estimating further comprises for the set of patents, computing at each time instance for each of the multiple categories, average percentage of patent applications receiving Office Action after a predefined time period from each time instance.

20. The tangible computer readable medium of claim 19 further comprising applying average percentage computed for each category to corresponding categories in the patent portfolio to estimate the number of Office Actions within the predefined time period for the patent portfolio.

21. A system for forecasting Office Actions for a patent portfolio, the system comprising:
one or more processors configured to:
perform predefined statistical analysis on a set of patents, wherein the set of patents and the patent portfolio have similar patent distribution;
identify one or more Office Action parameters associated with the set of patents and the patent portfolio based on the predefined statistical analysis performed on the set of patents; and
estimate the number of Office Actions issued for the patent portfolio based on the predefined statistical analysis performed on the set of patents and the identified Office Action parameters identified.
